(19) United States
(12) Patent Application Publication
(10) Pub. No.: US 2013/0086008 A1
(43) Pub. Date: Apr. 4, 2013

(54) USE OF MAILBOX FOR STORING METADATA IN CONFLICT RESOLUTION

(71) Applicants: Jeremy de Souza, Seattle, WA (US); Mayerber Carvalho Neto, Kirkland, WA (US); Komal Kashiramka, Redmond, WA (US); Ladislau Conceicao, Redmond, WA (US)

(72) Inventors: Jeremy de Souza, Seattle, WA (US); Mayerber Carvalho Neto, Kirkland, WA (US); Komal Kashiramka, Redmond, WA (US); Ladislau Conceicao, Redmond, WA (US)

(73) Assignee: Microsoft Corporation, Redmond, WA (US)

(21) Appl. No.: 13/252,972

(22) Filed: Oct. 4, 2011

(51) Int. Cl. G06F 17/00; G06F 7/00

(52) U.S. Cl. 707/692; 707/803; 707/E17.122

(57) ABSTRACT

Metadata associated with contact unification, which may involve conflict resolution and de-duplication, is stored in a user's mailbox for optimizing future automated unification operations, sharing of information between different clients and services, and providing relational data that can be used for other applications. User interactions regarding unification such as rejection or acceptance of automated actions, usage of created unified contacts, as well as data from external applications and services may be analyzed and stored in the mailbox. Such metadata may then be used to resolve conflicts the same user or other users in future contact unification operations and shared with other applications and services through a predefined schema such that those applications and services can update their data as well.

### BACKGROUND

Contemporary communication systems enable users to have a number of identities over various systems such as enterprise emails, personal emails, social networking exchanges, and comparable ones. Each of these systems may generate contact lists based on automatic processing of exchange information and/or manual input. A structure and content of contact information for distinct communication systems may be different depending on their infrastructure. Thus, a user may have a plurality of contact information for the same contact stored in each communication system they are associated with.

In a communication system where unification, de-duplication, and similar actions are taken on behalf of the user by the system to optimize processes and enhance user experience, conflicts may often occur. These conflicts may be duplicate contacts, perceived missing contacts, contacts which represents the same person but with different aspects of information, and so on. An automated system for processing contacts, calendar items, and comparable ones may not handle all situations with 100% accuracy. Some items may be missed, others may be resolved incorrectly. In such cases, user input may be used to correct errors and optimize information. However, in conventional systems, where unification is typically performed at a presentation layer, the corrections may be lost when a client application disconnects, is reset, or a client device lost.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to storing metadata associated with contact unification, which may involve conflict resolution and de-duplication, in a user's mailbox for optimizing future automated unification operations, sharing of information between different clients and services, and providing relational data that can be used for other applications. According to some embodiments, user interactions regarding unification such as rejection or acceptance of automated actions, usage of created unified contacts, as well as data from external applications and services may be analyzed and stored in the mailbox. Such metadata may then be used to resolve conflicts the same user or other users in future contact unification operations and shared with other applications and services through a predefined schema such that those applications and services can update their data as well.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 is a conceptual diagram illustrating a basic example of a system unifying contact information and collecting unification metadata in a mailbox;

FIG. 2 illustrates how a system according to embodiments can share contact unification metadata with other applications, services, and interact with a plurality of client applications for a user;

FIG. 3 illustrates a conceptual diagram of collecting and storing contact unification metadata in a system according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of collecting and storing contact unification metadata according to embodiments.

### DETAILED DESCRIPTION

As briefly described above, user interactions regarding unification such as rejection or acceptance of automated actions, usage of created unified contacts, as well as data from external applications and services may be analyzed and stored in a user's mailbox as unification metadata. The metadata may then be used to resolve conflicts the same user or other users in future contact unification operations and shared with other applications and services through a predefined schema such that those applications and services can update their data as well.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a contact may be a consolidated set of data needed to communicate with another user. Contact information may include the user's name, email address(es), telephone number(s), user-id(s), address(es), etc. Contact information may also include dynamic information such as a user's presence information including availability and location. Contact information may be retrieved from external sources to supplement primary contacts. Retrieved contact information may be in conflict with a primary contact (displayed by a communication application) due to a variety of reasons. Retrieved contact information may match the primary contact by having common identifier information such as a user's whole name or partial name, user id, text message id, and email address. The matching contact information may have information not found in the primary contact.

Throughout this specification, the term “server” generally refers to a computing device executing one or more software programs typically in a networked environment. However, a server may also be implemented as a virtual server (software programs) executed on one or more computing devices viewed as a server on the network. Similarly, a “client” may refer to a computing device enabling access to a communication system or an application executed on a computing device enabling a user to access a networked system such as a social networking service, an email exchange service, and comparable ones. More detail on these technologies and example operations is provided below.

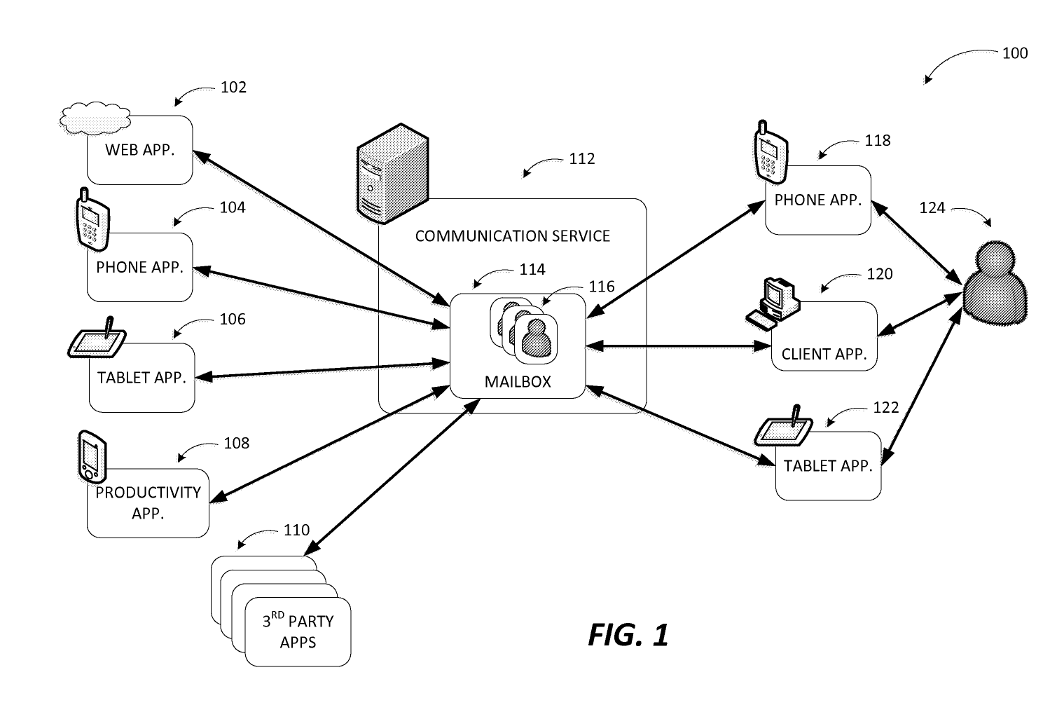

FIG. 1 is a conceptual diagram illustrating a basic example of a system unifying contact information and collecting unification metadata in a mailbox. A system according to embodiments is directed to aggregating multiple contacts from different sources into a unified profile view through contact linking while addressing conflicting data, duplicates, etc. automatically, and enhancing the automatic contact unification through analysis and storage of unification metadata in a centralized mailbox.

Contact linking and a logic person object for aggregated contact information may be preserved in a server-side mailbox as opposed to a client-side presentation layer for the user enabling efficient roaming through applications across different form factors and retrieval of contact information. If aggregation is performed at a presentation layer, the operations may need to be performed again each time the client device/application reconnects to the server or changes are made client-side. Additionally, the aggregated information (e.g., resolution of conflicts, duplicates, etc.) may be lost if the client-side data is lost or corrupted, client device is lost or damaged, and so on. A server-side mailbox 114, on the other hand, is usually backed up and secured through one or more mechanisms. Thus, not only is the aggregation process optimized, but the unified contact information 116 is preserved in a secure manner. Additionally, a user 124 may access the unified contact information 116 through multiple devices/applications (118, 120, and 122) as opposed to having the information reside on one client device/application only.

As shown in diagram 100, communication service 112 may provide single or multi modal communication services such as email, text messaging, audio/video communications, whiteboard sharing, data sharing, application sharing, conferencing, and similar ones. User 124 may access the services through client applications 118, 120, and 122. Client applications 118, 120, and 122 may be thin clients or rich clients. A thin client is typically a generic application such as a web browser that enables access to a hosted service through a user interface defined by the service and stores little or no data locally. A rich client is typically a special purpose application that may be installed locally on a client device and enable access to the same service with additional features storing some or all of the data also locally. In either case, connectivity is needed for the communications to be facilitated.

A contact is a collection of information about a person or entity that enables a user to establish different modes of communication with that person or entity, as well as view additional information. For example, a contact may include physical or email addresses, name, phone/fax numbers, text messaging id, social network id, and so on. A contact may also include ancillary information such as a person's title, organizational status, birthday, presence information (availability, location, etc.), and comparable data. Contacts may be created by various applications and services such as communication applications, social network services, even productivity applications that may provide multi-purpose services. Web application 102, phone application 104, tablet (or slate) application 106, productivity application 108, and third party applications 110 are examples of such applications that may have contact lists for a user. The contacts created by each application may have a different structure, content, or format.

Some of these applications and services may be local, hosted, or within an organizational network structure. Users may access these applications and services through special purpose client applications or generic client applications (e.g., browsers) directly or through an intermediary service. A user may have a number of contact lists maintained at different applications, local or hosted. Some of the contact lists may include contact data for the same person or entity with duplicate or conflicting information. In a system according to embodiments, communication service 112 may roam the related applications (102, 104, 106, 108, 110 etc.) retrieving contact information for a user of the service and create logic person objects for each distinct contact in mailbox 114. While creating the logic person objects, the service may resolve conflicts and eliminate duplicate data such that unified contact view can be presented to the user through a user interface at the client application 118, 120, and 122.

The information may be gathered centrally, regardless of the client's implementation of feedback collection. The mailbox 114 being a central hub may allow interception of indirect user feedback regardless of whether the client has implemented feedback collection on conflict resolution. User actions may be data-mined to un-link or link contacts to infer relationship value between two contacts.

According to some embodiments, stored metadata may be extended to other applications (102, 104, 106, 108, 110 etc.) such that one user's data informs the organizations' view of conflicts. Users' conflict resolution patterns may be combined within an organization or other social segment to draw conclusions about resolution strategies. For example, professionals, consumers, students, and similar groups may each have differing conflict resolution patterns. If multiple users resolve the same conflict the same way, that information may be applied to the segment including those users as a general pattern.

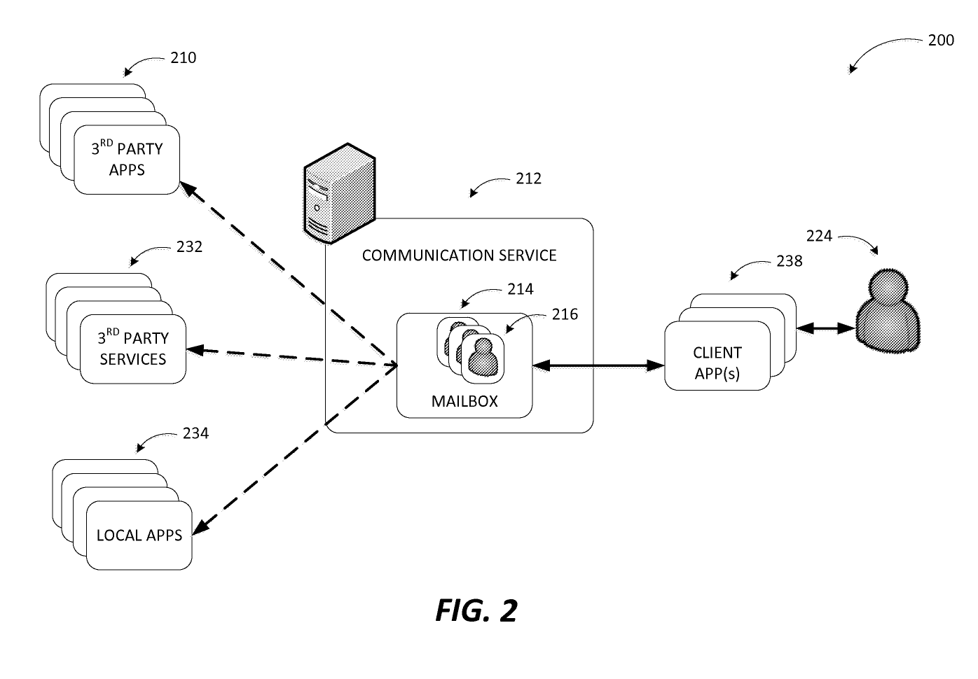

FIG. 2 illustrates in diagram 200 how a system according to embodiments can share contact unification metadata with other applications, services, and interact with a plurality of client applications for a user.

A system according to embodiments enables centralization of different data sources in the mailbox 214 as opposed to maintenance at a presentation layer of client application(s) 238, thus increasing the likelihood to link (find more duplicates, and provide enhanced unified views). For example, data from a corporate directory may be leveraged to ensure the user does not see someone they have in their contacts twice in search results if the contact exists in the company directory.

According to further embodiments, the stored metadata may be shared with other applications and services such as third party applications 210, third party services 232, and local applications 234. For example, third party services 232 may include social network or professional network services, third party applications 210 may include email or text messaging applications provided by hosted services, and local applications 234 may include other communication or productivity applications installed on a client device of user 224. A standardized schema may be used for describing the objects, the conflict, and the resolution (e.g., data source, identifiers, resolution type) such that other applications and services can efficiently utilize the metadata. The centralized service nature of the mailbox 214 used for storing the contact unification information 216 and the metadata may make it easier to look up the data such as local synchronization to mobile phone. Furthermore, a mechanism to share pertinent information if a data store does not have the contacts may be provided. For example, the key information of the contacts may be hashed so that other services can look for the same relationships without handing over the exact contact information objects.

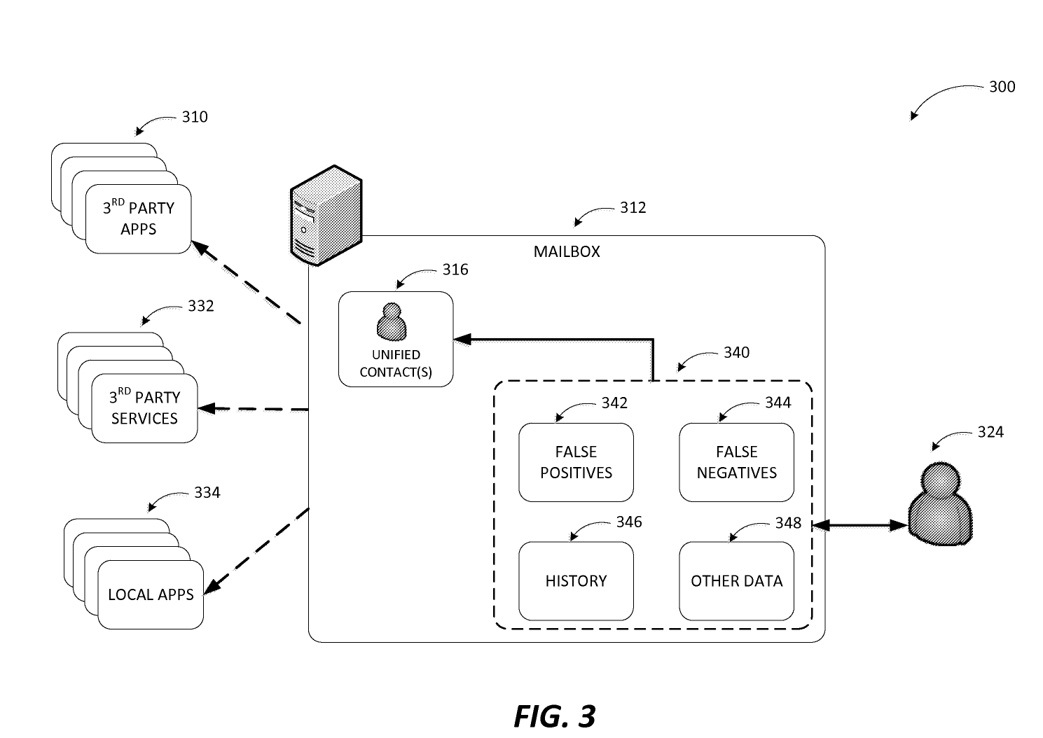

FIG. 3 illustrates a conceptual diagram 300 of collecting and storing contact unification metadata in a system according to embodiments.

According to some embodiments, user generated feedback on false positives 342 (conflicts resolved by the system incorrectly) may be gathered. For example, when a user 324 unlinks a contact breaking the system resolution, that action may be stored. When a user ignores a suggestion by the system, that action may also be stored. The user 324 may be allowed to vote on how reasonable the system resolution was using a rating scale. The user 324 may also be allowed to specify a text comment regarding why the resolution or suggestion was incorrect.

According to other embodiments, user generated feedback on false negatives 344 (conflicts that were not resolved by the system) may also be gathered and stored in the mailbox 312. The system may keep track of all the manual workflows by the user 324 to search/browse and manually link a contact (which contacts were missed). In these situations, the system may not have had enough information to resolve the conflict or make a suggestion. The user 324 may provide the link between two objects which do not share any common metadata 348.

The stored metadata 340 may be used as a feedback loop to engine informing future conflict resolution strategies. The history 346 of contact unification may be used as part of the metadata 340 such that the same conflicts are automatically resolved again (e.g., linking the two contacts again that were un-linked). The same bad suggestions may not be repeated (e.g., suggesting something the user ignored). A database of user provided data may be implemented to screen conflict resolution strategies.

Other data 348 gathered from the user may be correlated to other meta-data and/or statistics of the objects involved in the conflicts to inform future conflict resolution. For example, an age of the collected data, whether the objects were referenced equally by the user during the course of contact browsing, a system or application that created the objects involved in the conflicts, the user's geographical locale, the geographical locale of the contacts involved in the conflicts, whether the contacts are personal contacts versus work contacts, and similar factors may be used in analyzing the collected metadata 348 for use as feedback.

As discussed above, the stored metadata 340 and unified contact information 316 may be extended from mailbox 312 to third party applications 310, third party services 332, and local applications 334 through a standardizes schema. This may enable other applications and services to update their contact information and resolve conflicts internally.

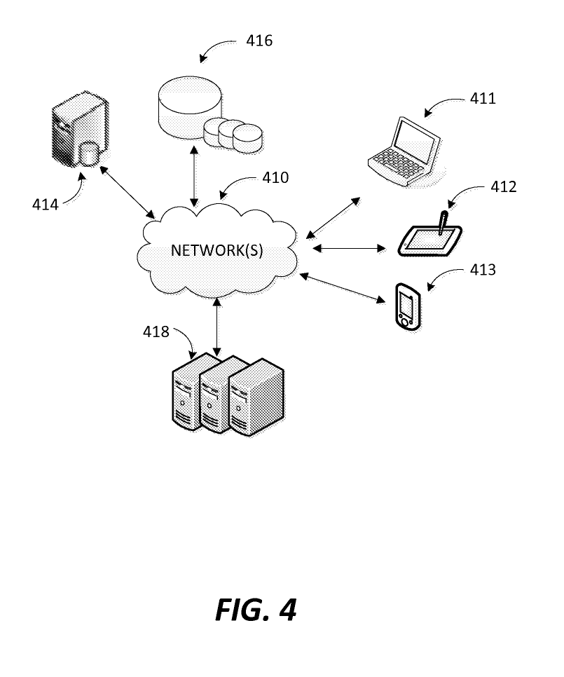

FIG. 4 is an example networked environment, where embodiments may be implemented. A communication service collecting and storing contact unification metadata in a mailbox may be implemented via software executed over one or more servers 418 such as a hosted service. The service may facilitate communications between client applications on individual computing devices such as a smart phone 413, a tablet computer 412, laptop computer 411, and a desktop computer (client devices') through network(s) 410.

As discussed, the communication service may aggregate multiple contacts into a unified profile view through contact linking to a logic person object that is persisted in a mailbox addressing conflicting data, duplicates, etc. The communication service may also collect and store metadata associated with resolving conflicts, de-duplicating, and user interactions with the contact unification process (as well as usage) in the mailbox. The metadata may be used for future conflict resolution and extended to other applications.

Client devices 411-413 are used to facilitate communications through a variety of modes between users of the communication application. One or more of the servers 418 may be used to manage contact information as discussed above. Contact information and metadata may be stored in one or more data stores (e.g. data store 416), which may be managed by any one of the servers 418 or by database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to persist aggregated contact information in a mailbox. Furthermore, the networked environments discussed in FIG. 4 are for illustration purposes only. Embodiments are not limited to the example applications, modules, or processes.

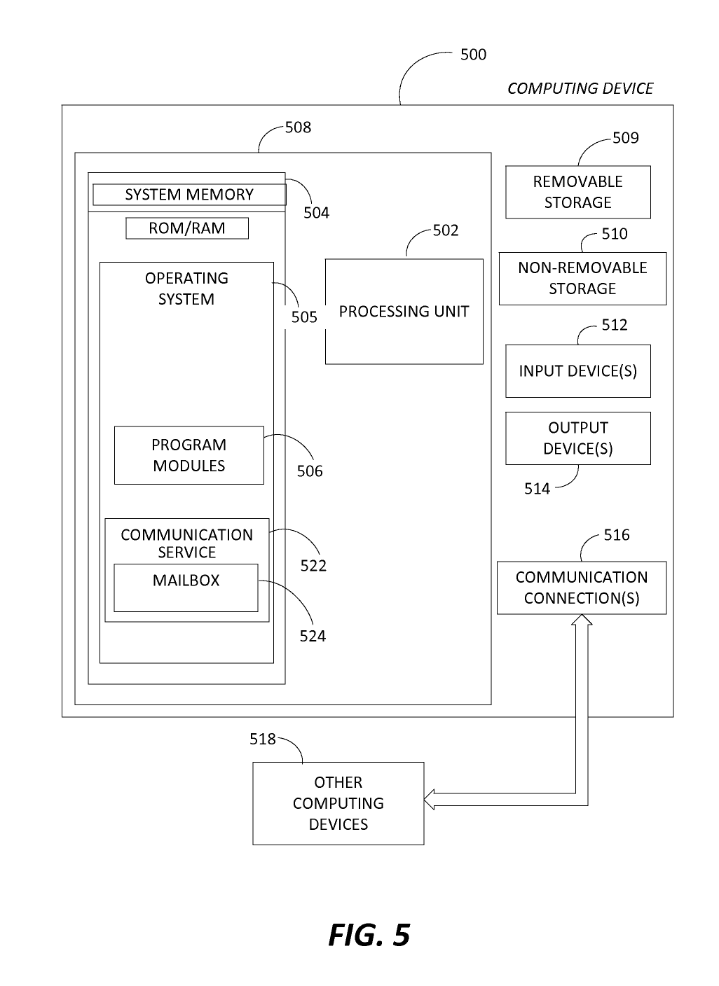

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server as part of a communication system and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS®, operating systems from MICROSOFT CORPORATION of Redmond, Wash. The system memory 504 may also include one or more software applications such as program modules 506, communication service 522, and mailbox 524.

Communication service 522 may be a single hosted application or a collection of hosted and/or locally installed applications providing single or multi-modal communication services to users through rich or thin clients. As part of the facilitated services, communication service 522 may aggregate multiple contacts into a unified profile view through contact linking to a logic person object that is persisted in mailbox 524 addressing conflicting data, duplicates, etc. The communication service 522 may also collect and store metadata associated with resolving conflicts, de-duplicating, and user interactions with the contact unification process (as well as usage) in the mailbox 524. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

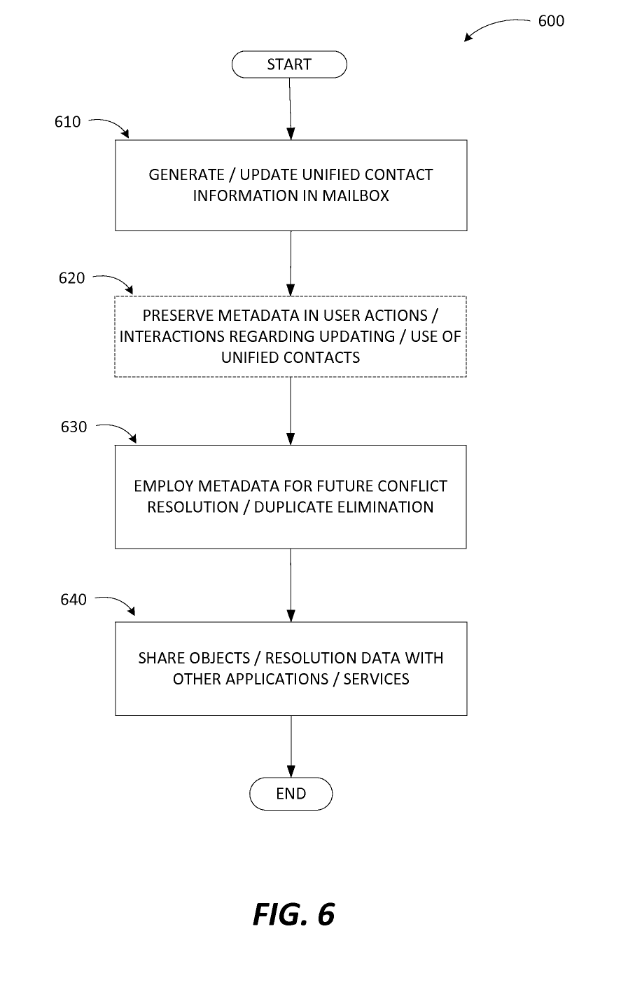

FIG. 6 illustrates a logic flow diagram for a process of collecting and storing contact unification metadata according to embodiments. Process 600 may be implemented as part of a communication application that automatically unifies contact information.

Process 600 begins with operation 610, where the communication application may generate and update unified contact information in a centralized mailbox through conflict resolution, de-duplication, etc. During the process, the application may collect and analyze metadata such as user acceptations, rejections, and modifications of generated unified contact information. The application may also collect other usage data, location data, and so on at operation 620 and preserve as metadata. This may be used as a feedback tool for future conflict resolutions.

At operation 630, the metadata may be used in subsequent conflict resolution and de-duplication operations enhancing an accuracy of the automated contact unification and avoiding repeated wrong suggestions to a user. At operation 640, the objects and resolution data may be shared with other applications and services such that those can update their contact information and avoid conflicts that have already been resolved by the communication application.

The operations included in process 600 are for illustration purposes. Collecting and storing contact unification metadata in a mailbox according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for collecting and storing contact unification metadata in a centralized mailbox, the method comprising:
generating unified contact information for one or more contacts retrieved from a plurality of sources by aggregating the retrieved contact information at the mailbox;
collecting metadata associated with a contact information unification process and one or more user actions associated with the unified contact information;
storing the metadata at the mailbox; and
employing the metadata for subsequent contact information unification processes.

2. The method of claim 1, further comprising:
rendering the stored metadata available to at least one application employing a predefined schema.

3. The method of claim 2, wherein the predefined schema includes a description of at least one from a set of: a data source, an identifier, and a resolution type.

4. The method of claim 2, further comprising:
hashing key information associated with contacts such that the at least one application receiving the stored metadata is unable to identify a particular contact.

5. The method of claim 1, further comprising:
aggregating the retrieved contact information by automatically resolving conflicts and eliminating duplicate information.

6. The method of claim 1, wherein the metadata is employed for the subsequent contact unification processes based on at least one from a set of: an age of the collected metadata, whether generated unified contacts are referenced equally by a user, a source associated with contacts involved in conflicts, the user's geographical locale, a geographical locale of one or more contacts involved in the conflicts, and whether a contact is a personal contacts or a work contact.

7. The method of claim 1, wherein the sources include at least one from a set of: a phone application, a slate application, a directory, a social network service, a professional network service, a search engine, and a productivity application.

8. The method of claim 1, wherein the metadata includes user feedback for false positives representing incorrectly resolved conflicts and false negatives representing not resolved conflicts.

9. The method of claim 8, wherein the feedback for the false positives is collected by one or more of:
storing an unlinking action;
storing an ignore action to a suggested contact linking;
enabling the user to vote on how reasonable a conflict resolution was using a rating scale; and
enabling the user to specify a text comment regarding why a conflict resolution was incorrect.

10. The method of claim 8, wherein the feedback for the false negatives is collected by tracking manual workflows by a user to search and manually link a contact.

11. The method of claim 1, further comprising:
determining a user's conflict resolution pattern for past contact unification processes; and
employing the user's conflict resolution pattern in the subsequent contact unification processes.

12. The method of claim 1, further comprising:
generating a database of user-provided conflict resolution data for adjusting conflict resolution strategies in the subsequent contact unification processes.

13. A communication server for collecting and storing contact unification metadata in a centralized mailbox, the server comprising:
a memory;
a processor coupled to the memory, the processor executing a communication application, wherein the communication application is configured to:
generate unified contact information for one or more contacts retrieved from a plurality of sources by aggregating the retrieved contact information at the mailbox through at least one of conflict resolution and de-duplication;
collect metadata associated with a contact information unification process and one or more user actions associated with the unified contact information;
store the collected metadata at the mailbox;
adjust one of a conflict resolution strategy and a de-duplication strategy for subsequent contact information unification processes based on the stored metadata; and
render the stored metadata available to at least one application employing a predefined schema.

14. The server of claim 13, wherein the communication application is further configured to:
collect the metadata through the mailbox independent of a metadata collection capability of a client application employed by a user to access the communication application.

15. The server of claim 13, wherein the communication application is further configured to:
data-mine user actions associated with linking and unlinking contacts; and
infer a relationship value between contacts based on the user actions.

16. The server of claim 13, wherein the communication application is configured to facilitate at least one from a set of: email exchange, text message exchange, audio communication, video communication, whiteboard sharing, data sharing, application sharing, and conferencing.

17. The server of claim 13, wherein the communication application is further configured to:
correlate metadata gathered from a user to other metadata and statistical information associated with contacts involved in a conflict to adjust the conflict resolution strategy.

18. A computer-readable memory device with instructions stored thereon for collecting and storing contact unification metadata in a centralized mailbox, the instructions containing:
generating unified contact information for one or more contacts retrieved from a plurality of sources by aggregating the retrieved contact information at the mailbox through at least one of conflict resolution and de-duplication;
collecting metadata associated with a contact information unification process and one or more user actions associated with the unified contact information;
storing the collected metadata at the mailbox;
correlating the stored metadata gathered from a user to other metadata and statistical information associated with contacts involved in a conflict;
adjusting one of a conflict resolution strategy and a de-duplication strategy for subsequent contact information unification processes based on the stored metadata and the correlation; and
rendering the stored metadata available to at least one application employing a predefined schema.

19. The computer-readable memory device of claim 18, wherein the instructions further comprise:
determining conflict resolution patterns of one or more users within group for past contact unification processes;
inferring a resolution strategy for the group from the conflict resolution patterns; and
employing the resolution strategy in the subsequent contact unification processes for the group.

20. The computer-readable memory device of claim 19, wherein the group is one of an organization, a professional group, and a social group.
